(19) United States
(12) Patent Application Publication
(10) Pub. No.: US 2023/0128046 A1
(43) Pub. Date: Apr. 27, 2023

(54) DETECTION METHOD AND COMPUTER-READABLE RECORDING MEDIUM STORING DETECTION PROGRAM

(71) Applicant: FUJITSU LIMITED, Kawasaki-shi (JP)

(72) Inventor: Jun-ichi Nagata, Kawasaki (JP)

(73) Assignee: FUJITSU LIMITED, Kawasaki-shi, Kanagawa (JP)

(21) Appl. No.: 17/381,923

(22) Filed: Jul. 21, 2021

Related U.S. Application Data
(63) Continuation of application No. PCT/JP2019/007710, filed on Feb. 27, 2019.

(51) Int. Cl. G01S 19/42; G01S 19/29; G01S 19/34

(52) U.S. Cl. CPC G01S 19/425; G01S 19/29; G01S 19/34

(57) ABSTRACT

A detection method includes: calculating, based on a result of a device having received data from five or more satellites at a first time point, a solution to an equation including first to third variables indicating a three-dimensional position of the device, a fourth variable indicating deviation of internal time of the device, and a fifth variable indicating a time lag caused by a Doppler effect between the device and the satellites; calculating a solution to an equation including the first to fourth variables based on a result of the device received data from four satellites at a second time point different from the first time point and a solution to the fifth variable calculated for the first time point; and outputting positional information of the device based on calculated each solution to the first to third variables for each of the first time point and the second time point.

### CROSS-REFERENCE TO RELATED APPLICATION

This application is a continuation application of International Application PCT/JP2019/007710 filed on Feb. 27, 2019 and designated the U.S., the entire contents of which are incorporated herein by reference.

### FIELD

The embodiment discussed herein is related to a detection method and a detection program.

### BACKGROUND

Positioning systems using artificial satellites, such as a global navigation satellite system (GNSS), have been known.

Japanese National Publication of International Patent Application No. 2012-524273, Japanese Laid-open Patent Publication No. 2011-257415, and Japanese Laid-open Patent Publication No. 2013-217925 are disclosed as related art.

### SUMMARY

According to an aspect of the embodiments, a detection method includes: calculating, based on a result of a device having received data from five or more satellites at a first time point, a solution to an equation including first to third variables indicating a three-dimensional position of the device, a fourth variable indicating deviation of internal time of the device, and a fifth variable indicating a time lag caused by a Doppler effect between the device and the satellites; calculating a solution to an equation including the first to fourth variables based on a result of the device received data from four satellites at a second time point different from the first time point and a solution to the fifth variable calculated for the first time point; and outputting positional information of the device based on calculated each solution to the first to third variables for each of the first time point and the second time point.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary terminal position detection system according to an embodiment;

FIG. 2 is a diagram illustrating an exemplary change in the number of captured satellites by a device according to the embodiment;

FIG. 3 is a diagram illustrating an exemplary detection device according to the embodiment;

FIG. 4 is a diagram illustrating an exemplary hardware configuration of the detection device according to the embodiment;

FIG. 5 is a flowchart illustrating an exemplary process by the detection device according to the embodiment;

FIG. 6 is a diagram illustrating exemplary positioning based on measurement data associated with four satellites by the detection device according to the embodiment;

FIG. 7 is a diagram illustrating exemplary identification of a moving route using the detection device according to the embodiment;

FIG. 8 is a diagram illustrating exemplary trace information to be obtained by the detection device according to the embodiment;

FIG. 9 is a diagram illustrating an exemplary first method of calculating positioning data by the detection device according to the embodiment;

FIG. 10 is a diagram illustrating an exemplary second method of calculating positioning data by the detection device according to the embodiment;

FIG. 11 is a flowchart illustrating an exemplary normal snapshot positioning operation by the detection device according to the embodiment;

FIG. 12 is a diagram illustrating an example of each information to be calculated in the normal snapshot positioning operation by the detection device according to the embodiment;

FIG. 13 is a diagram illustrating exemplary calculation of a solution in the normal snapshot positioning operation by the detection device according to the embodiment;

FIG. 14 is a flowchart illustrating an exemplary snapshot positioning operation using reference source data by the detection device according to the embodiment;

FIG. 15 is a diagram illustrating an example of each information to be calculated in the snapshot positioning operation using the reference source data by the detection device according to the embodiment; and

FIG. 16 is a diagram illustrating exemplary calculation of a solution in the snapshot positioning operation using the reference source data by the detection device according to the embodiment.

### DESCRIPTION OF EMBODIMENTS

For example, there has been known a method of calculating, as a positioning solution, a solution to an equation including XYZ coordinates of a device and a time lag of the device as variables by using a result of the device to be positioned having received data from four or more satellites. Furthermore, there has been known snapshot positioning capable of obtaining a positioning solution even when a device receives data from satellites only for a short time by using a result of the device to be positioned having received data from five or more satellites.

However, there may be a case where, in the snapshot positioning, the number of satellites to be captured by the device does not reach a predetermined number when the device to be positioned and the satellite are obstructed by a building or the like, for example, and a positioning solution may not be obtained.

In one aspect, a detection method and a detection program capable of obtaining a positioning solution even in a case where the number of captured satellites is less than a predetermined number may be provided.

Hereinafter, an embodiment of a detection method and a detection program according to the present embodiment will be described in detail with reference to the drawings.

### Embodiment

### Terminal Position Detection System According to Embodiment

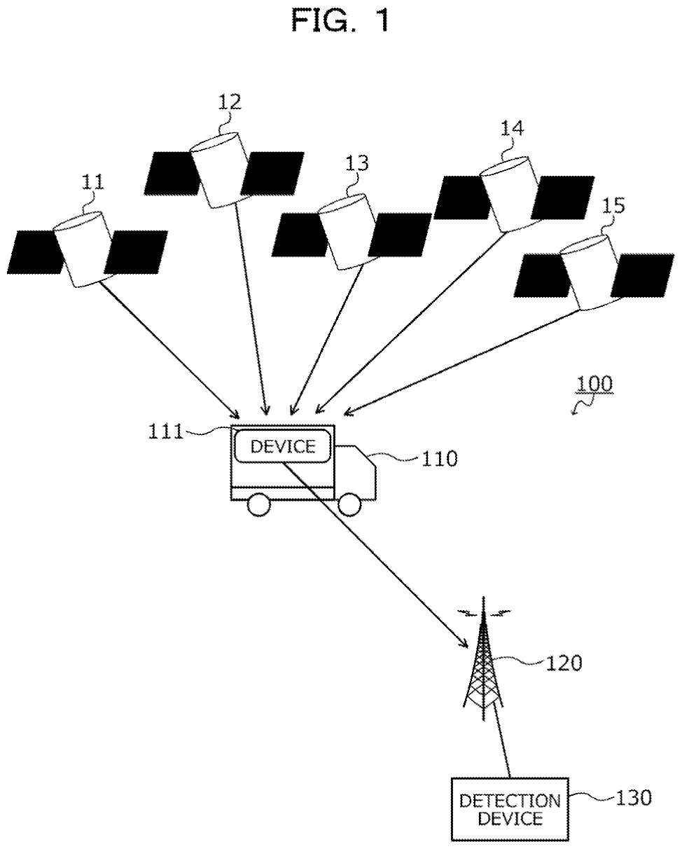

FIG. 1 is a diagram illustrating an exemplary terminal position detection system according to an embodiment. As illustrated in FIG. 1, a terminal position detection system 100 according to the embodiment includes a device 111, a receiving station 120, and a detection device 130.

The device 111 is a terminal to be subject to positioning by the terminal position detection system 100. In the example illustrated in FIG. 1, the device 111 is mounted on a truck 110, and as a result, a position of the truck 110 is detected by the terminal position detection system 100. The position of the truck 110 is represented by, for example, latitude and longitude.

For example, the terminal position detection system 100 generates a time series of detection results of the current position of the truck 110 as trace information. This enables a carrier that manages trucking using the truck 110 to identify the route that the truck 110 has traveled on the basis of the trace information of the truck 110, for example.

Each of satellites including satellites 11 to 15 is an artificial satellite existing in the orbit of the Earth as a positioning satellite. Each of the satellites wirelessly transmits data including, for example, time information based on an atomic clock mounted on each of them. The device 111 is capable of receiving the data wirelessly transmitted from each satellite.

The number of satellites captured by the device 111 (hereinafter also referred to as “the number of captured satellites”) differs depending on the position of the device 111 at that time and a shield (building, etc.) between the device 111 and each satellite. Capturing of a satellite by the device 111 indicates, for example, the device 111 can receive data wirelessly transmitted from that satellite.

The device 111 wirelessly transmits information based on data from one or more satellites received at a certain time point to the receiving station 120 as measurement data for identifying the position of the device 111 at that time point. As described above, in the case of generating trace information of the truck 110 in the terminal position detection system 100, the device 111 repeatedly (e.g., periodically) receives data from the satellite and wirelessly transmits the measurement data.

The receiving station 120 is a base station fixed on the ground, for example, and is capable of wirelessly communicating with the device 111. For example, the receiving station 120 receives the measurement data wirelessly transmitted from the device 111, and transmits the received measurement data to the detection device 130. At this time, the receiving station 120 may add a time stamp indicating the internal time of the receiving station 120 at the time of receiving the measurement data to the measurement data to be transmitted to the detection device 130. The communication between the receiving station 120 and the detection device 130 may be wireless communication, or may be wired communication.

The detection device 130 detects the current position of the device 111 on the basis of the measurement data received from the receiving station 120. For example, the detection device 130 calculates a solution (including approximate solution) to simultaneous equations based on the measurement data associated with one or more satellites captured by the device 111 by the least squares method or the like, thereby detecting the current position of the device 111.

Here, in the terminal position detection system 100, snapshot positioning in which positioning calculation is performed only from a code phase and a Doppler frequency is used as a method of positioning of the device 111. The snapshot positioning is, for example, a positioning method in which the detection device 130 uses simultaneous equations including five variables (e.g., variables X, Y, Z, t, and dt to be described later) to obtain a positioning solution for the device 111.

In the snapshot positioning, it becomes possible to reduce the time for receiving, using the device 111, data from a satellite for one positioning as compared with a positioning method using simultaneous equations including four variables (e.g., variables X, Y, Z, and t to be described later) (referred to as a normal positioning method).

For example, in the normal positioning method, the device 111 needs to receive data from a satellite for approximately 30 seconds for one positioning. On the other hand, in the snapshot positioning, it is sufficient if the device 111 receives data from a satellite for only several milliseconds (e.g., approximately 4 [ms] or 100 [ms]) for one positioning.

Therefore, in the terminal position detection system 100, the device 111 receives data from a satellite for a time (several milliseconds) sufficient for the snapshot positioning. Accordingly, the power consumption of the device 111 may be reduced.

However, since a solution to the simultaneous equations including five variables is calculated in the snapshot positioning, measurement data associated with five or more satellites is required for one positioning. Therefore, the snapshot positioning requires that the device 111 capture five or more satellites (e.g., satellites 11 to 15). Hereinafter, the snapshot positioning using measurement data associated with five or more satellites will be referred to as normal snapshot positioning.

Meanwhile, the detection device 130 is capable of detecting, even at a time point when the device 111 can capture only four satellites, for example, a position of the device 111 on the basis of the measurement data of the four satellites obtained through the reception for several milliseconds by the device 111. The method of this detection will be described later.

Furthermore, in the terminal position detection system 100, a positioning method is used in which detection of the position of the device 111 is carried out not by the device 111 but by the external detection device 130. For example, in a case where the detection device 130 is implemented by cloud computing, such a positioning method is called, for example, a cloud offloaded-global positioning system (CO-GPS). In snapshot positioning of the CO-GPS, the fifth variable (dt) of the five variables mentioned above is called a coarse time error (e).

### Change in the Number of Captured Satellites by Device According to Embodiment

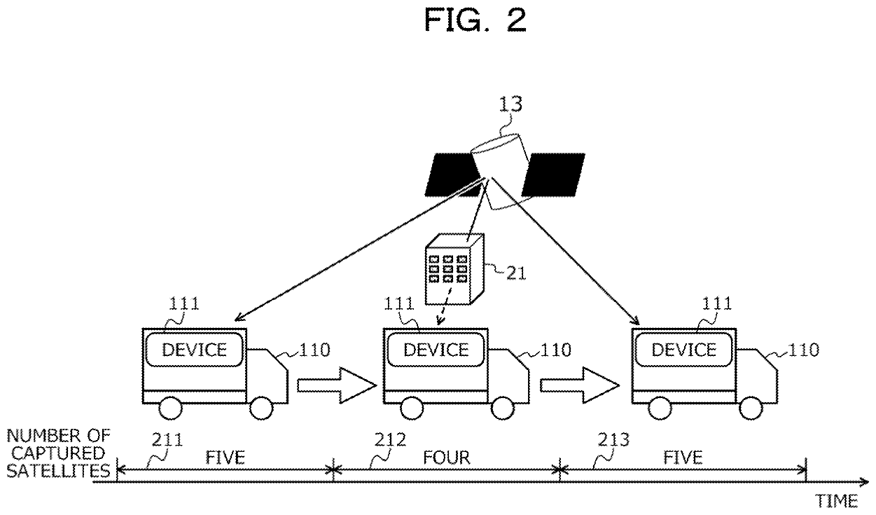

FIG. 2 is a diagram illustrating an exemplary change in the number of captured satellites by a device according to the embodiment. For example, it is assumed that the truck 110 has traveled in the order of a section 211, a section 212, and a section 213. At this time, it is assumed that data from a satellite 13 is blocked by a shield 21, such as a building, and the device 111 has failed to capture the satellite 13 in the section 212. However, it is assumed that, in each of the sections 211 to 213, the device 111 has captured satellites 11, 12, 14, and 15. Furthermore, it is also assumed that the satellite 13 has been captured in the sections 211 and 213.

In this case, the number of captured satellites by the device 111 in the sections 211 to 213 is five, four, and five, respectively. Therefore, while a positioning solution of the device 111 can be obtained by the normal snapshot positioning for the sections 211 and 213, a positioning solution of the device 111 cannot be obtained by the normal snapshot positioning for the section 212.

Meanwhile, the detection device 130 calculates a positioning solution of the device 111 by the normal snapshot positioning for the sections 211 and 213. Furthermore, for the section 212, the detection device 130 calculates a positioning solution of the device 111 in the section 212 by the snapshot positioning using the positioning solution of the device 111 in the section near the section 212 (e.g., section 211 or section 213).

### Detection Device According to Embodiment

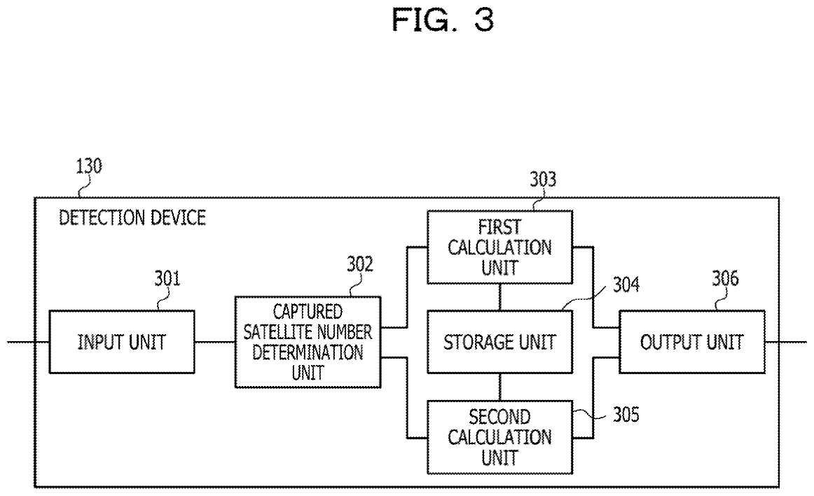

FIG. 3 is a diagram illustrating an example of the detection device according to the embodiment. As illustrated in FIG. 3, the detection device 130 includes an input unit 301, a captured satellite number determination unit 302, a first calculation unit 303, a storage unit 304, a second calculation unit 305, and an output unit 306, for example.

Measurement data, which is a result of the device 111 having received data from a satellite at each time point, is input to the input unit 301. The input unit 301 outputs the measurement data for each input time point to the captured satellite number determination unit 302.

The captured satellite number determination unit 302 determines how many satellites the measurement data output from the input unit 301 is associated with. Then, the captured satellite number determination unit 302 outputs the measurement data associated with five or more satellites to the first calculation unit 303, and outputs the measurement data associated with four satellites to the second calculation unit 305. The measurement data associated with three or less satellites is discarded by the captured satellite number determination unit 302, for example.

The first calculation unit 303 calculates a solution to a first equation including variables X, Y, Z, t, and dt (first to fifth variables) on the basis of the measurement data associated with five or more satellites output from the captured satellite number determination unit 302. The variables X, Y, and Z are variables that indicate XYZ coordinates (three-dimensional position) of the device 111. For example, the variable X (first variable) indicates an X-coordinate of the device 111, the variable Y (second variable) indicates a Y-coordinate of the device 111, and the variable Z (third variable) indicates a Z-coordinate of the device 111.

The variable t (fourth variable) is a variable that indicates a deviation of the internal time of the device 111 with respect to the time based on the atomic clock of each satellite. The variable dt (fifth variable) is a variable that indicates a time lag between the device 111 and a satellite based on Doppler effects caused by the device 111 receiving data from the satellite for a short time as described above. For example, calculation of a solution by the first calculation unit 303 is calculation of a solution using the snapshot positioning operation based on the measurement data associated with five or more satellites.

The first calculation unit 303 outputs, for example, calculated solutions to the variables X, Y, and Z to the output unit 306. Furthermore, the first calculation unit 303 outputs a calculated solution to the variable dt to the storage unit 304. The storage unit 304 stores the solution to the variable dt output from the first calculation unit 303 as reference source data that can be referred to by the second calculation unit 305.

The second calculation unit 305 calculates a solution to a second equation including the variables X, Y, Z, and t (first to fourth variables) on the basis of the measurement data associated with four satellites output from the captured satellite number determination unit 302 and the solution to the variable dt stored by the storage unit 304 as reference source data. The second equation is, for example, an equation in which the value of the variable dt is fixed to the solution to the variable dt stored by the storage unit 304 in the first equation mentioned above. The second calculation unit 305 outputs, for example, calculated solutions to the variables X, Y, and Z to the output unit 306.

Furthermore, in a case where the solution to the variable dt calculated for a plurality of time points is stored in the storage unit 304, the second calculation unit 305 may calculate a solution using the solution to the variable dt calculated for the immediately preceding time point. The immediately preceding time point is, for example, one time point (first time point) immediately before a second time point at which the measurement data output from the captured satellite number determination unit 302 to the second calculation unit 305 is received among the respective time points at which the device 111 receives data from the satellite. This makes it possible to accurately estimate the position of the device 111 at the time point when only the measurement data for four satellites has been obtained.

However, the solution to the variable dt to be used by the second calculation unit 305 is not limited to the solution calculated for the immediately preceding time point, and it may be a solution calculated for one time point immediately after, the average of the respective solutions calculated for the respective immediately preceding and immediately following time points, or the like.

The output unit 306 outputs positional information of the device 111 based on the solutions to the variables X, Y, and Z output from the first calculation unit 303, and positional information of the device 111 based on the solutions to the variables X, Y, and Z output from the second calculation unit 305, respectively. This makes it possible to obtain not only the positional information of the device 111 at the time point when the measurement data associated with five or more satellites has been obtained but also the positional information of the device 111 at the time point when only the measurement data associated with four satellites has been obtained.

For example, the output unit 306 outputs the positional information of the device 111 in association with the time at which the device 111 has received the data used for the calculation of the positional information of the device 111. This makes it possible to obtain trace information indicating the time series of the positional information of the device 111.

Various output methods may be used as a method for outputting positional information using the output unit 306. For example, it is possible to adapt various types of output for the output of the positional information by the output unit 306, such as display using a display, audio output using a speaker, output to a printing device or a storage device, and transmission to another communication device via a network.

### Hardware Configuration of Detection Device According to Embodiment

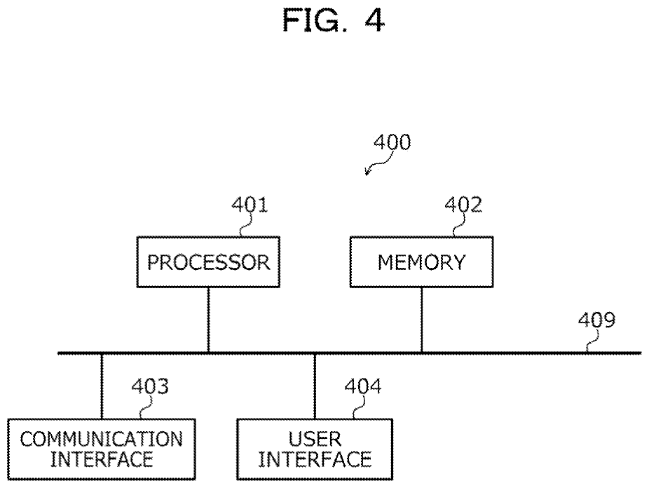

FIG. 4 is a diagram illustrating an exemplary hardware configuration of the detection device according to the embodiment. The detection device 130 illustrated in FIG. 3 may be constructed by an information processing apparatus 400 illustrated in FIG. 4, for example. The information processing apparatus 400 includes a processor 401, a memory 402, and a communication interface 403. Furthermore, the information processing apparatus 400 may include a user interface 404. The processor 401, the memory 402, the communication interface 403, and the user interface 404 are connected by a bus 409, for example.

The processor 401 is a circuit that performs signal processing, and is, for example, a central processing unit (CPU) that controls the entire information processing apparatus 400. The memory 402 includes a main memory and an auxiliary memory, for example. The main memory is a random access memory (RAM), for example. The main memory is used as a work area for the processor 401.

The auxiliary memory is a non-volatile memory such as a magnetic disk, an optical disk, and a flash memory, for example. The auxiliary memory stores various programs for operating the information processing apparatus 400. The program stored in the auxiliary memory is loaded to the main memory, and is executed by the processor 401.

Furthermore, the auxiliary memory may include a portable memory that can be removed from the information processing apparatus 400. Examples of the portable memory include a universal serial bus (USB) flash drive, a memory card such as a secure digital (SD) memory card, an external hard disk drive, and the like.

The communication interface 403 is a communication interface that communicates with the outside of the information processing apparatus 400 (e.g., receiving station 120). The communication interface 403 is controlled by the processor 401.

The user interface 404 includes, for example, an input device that receives operation input from a user (e.g., administrator of trace information of the truck 110), an output device that outputs information to the user, and the like. The input device may be constructed by, for example, a pointing device (e.g., mouse), a key (e.g., keyboard), a remote controller, or the like. The output device may be constructed by, for example, a display, a speaker, or the like. Furthermore, the input device and the output device may be constructed by a touch panel or the like. The user interface 404 is controlled by the processor 401.

The input unit 301 illustrated in FIG. 3 may be constructed by, for example, the communication interface 403. The captured satellite number determination unit 302, the first calculation unit 303, and the second calculation unit 305 illustrated in FIG. 3 may be constructed by, for example, the processor 401 and the memory 402. The input unit 301 illustrated in FIG. 3 may be constructed by, for example, the memory 402. The output unit 306 illustrated in FIG. 3 may be constructed by, for example, the memory 402 or the communication interface 403.

### Process by Detection Device According to Embodiment

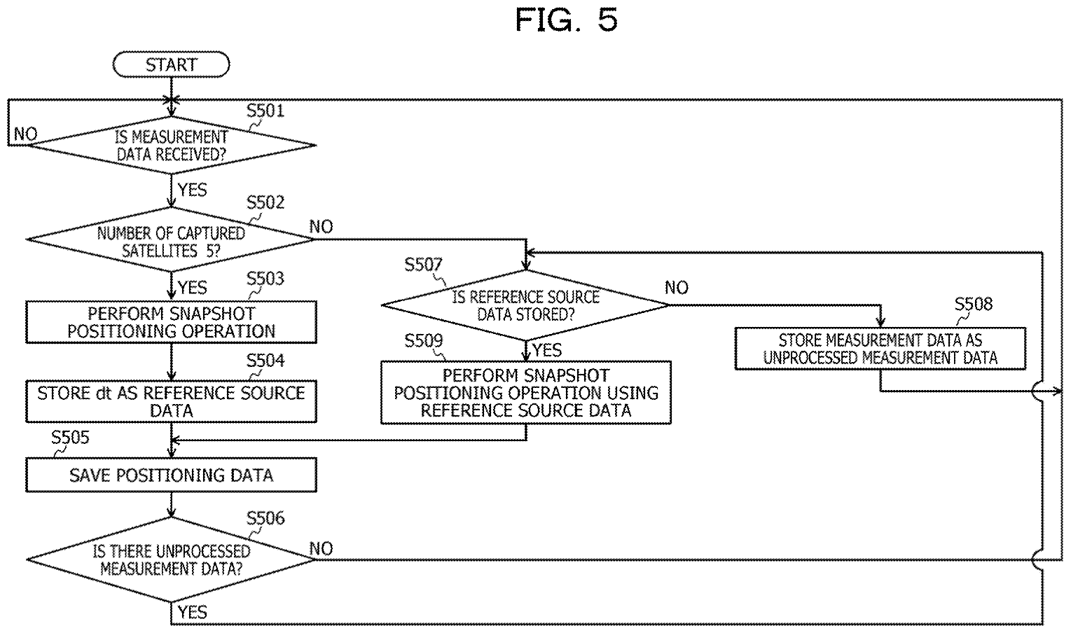

FIG. 5 is a flowchart illustrating an exemplary process by the detection device according to the embodiment. The detection device 130 according to the embodiment executes each step illustrated in FIG. 5, for example. First, the detection device 130 determines whether or not measurement data associated with one or more satellites transmitted from the device 111 via the receiving station 120 has been received (step S501), and waits until the measurement data is received (“No” loop in step S501).

Measurement data associated with a certain satellite is, for example, information including information capable of identifying the code phase of data received from the satellite by the device 111, the identification number of the satellite, and a time stamp indicating the time at which the measurement data is obtained.

Upon receiving the measurement data in step S501 (Yes in step S501), the detection device 130 determines whether or not the number of satellites captured by the device 111 (the number of captured satellites) is five or more (step S502). For example, the detection device 130 determines whether or not the received measurement data is measurement data associated with five or more satellites.

In step S502, if the number of captured satellites is five or more (Yes in step S502), the detection device 130 performs a normal snapshot positioning operation on the basis of the received measurement data associated with five or more satellites (step S503). This normal snapshot positioning operation will be described later. According to the snapshot positioning operation in step S503, solutions to the variables X, Y, and Z indicating the XYZ coordinates of the device 111 and the variables t and dt indicating the time lag between the device 111 and the satellite are obtained.

Next, the detection device 130 stores the solution to the variable dt (fifth variable) obtained through the snapshot positioning operation in the memory 402 as reference source data (step S504). At this time, the detection device 130 may also store the time stamp of the measurement data used in the snapshot positioning operation in the memory 402 as reference source data. Furthermore, in a case where the solution to the variable dt obtained through the snapshot positioning operation has been stored in the memory 402 as the reference source data, the detection device 130 may overwrite the solution stored in the memory 402 with the newly obtained solution to the variable dt and stores it.

Next, the detection device 130 saves positioning data calculated on the basis of the solutions to the variables X, Y, and Z obtained through the snapshot positioning operation (step S505). The positioning data is information obtained by converting the XYZ coordinates of the device 111 indicated by the solutions to the variables X, Y, and Z into a coordinate system of latitude, longitude, and altitude, for example.

Furthermore, the detection device 130 may save the calculated positioning data in association with the measurement time in step S505. The measurement time is, for example, the time indicated by the time stamp added to the measurement data used for the calculation of the positioning data. Furthermore, the measurement time may be time corrected on the basis of the solutions to the variables t and dt.

Next, the detection device 130 determines whether or not there is unprocessed measurement data that has been stored in step S508 to be described later and has not been processed in step S509 to be described later (step S506). If there is no unprocessed measurement data (No in step S506), the detection device 130 returns to step S501.

If the number of captured satellites is not five or more in step S502 (No in step S502), the detection device 130 determines whether or not the reference source data (solution to the variable dt) has been stored in step S504 (step S507). If the reference source data is not stored (No in step S507), the detection device 130 stores the received measurement data (measurement data associated with four or less satellites) as unprocessed measurement data (step S508), and returns to step S501.

If the reference source data is stored in step S507 (Yes in step S507), the detection device 130 proceeds to step S509. For example, the detection device 130 performs snapshot positioning operation using the stored reference source data on the basis of, for example, the received measurement data associated with four satellites (step S509). The snapshot positioning operation using the reference source data in step S509 will be described later.

According to the snapshot positioning operation in step S509, in a similar manner to step S503, solutions to the variables X, Y, and Z indicating the XYZ coordinates of the device 111 and the variables t and dt indicating the time lag between the device 111 and the satellite are obtained. Subsequent to step S509, the detection device 130 proceeds to step S505, and saves the positioning data calculated on the basis of the solutions (e.g., solutions to the variables X, Y, and Z) obtained through the snapshot positioning operation in step S509.

If there is unprocessed measurement data in step S506 (Yes in step S506), the detection device 130 proceeds to step S507. At this time, in the case of shifting from step S507 to step S509, the detection device 130 performs the snapshot positioning operation using the reference source data on the basis of, for example, the unprocessed measurement data associated with four satellites in step S509.

As illustrated in FIG. 5, in a case where measurement data associated with five or more satellites has been received, the detection device 130 performs normal snapshot positioning operation and saves the obtained positioning data. Furthermore, at this time, the detection device 130 stores the solution to the variable dt obtained through the normal snapshot positioning operation as reference source data.

Furthermore, in a case where measurement data associated with only four satellites has been received, the detection device 130 performs snapshot positioning operation using reference source data if the reference source data is stored, and stores the measurement data as unprocessed measurement data if the reference source data is not stored.

As an example, it is assumed that the number of captured satellites in the measurement data has changed such as four, four, five, and so on. The first measurement data and the second measurement data, in which the number of captured satellites is four, are not subject to the snapshot positioning operation, and each of them is stored as unprocessed measurement data.

Then, the third measurement data in which the number of captured satellites is five is subject to the normal snapshot positioning operation, and the positioning data is saved. Furthermore, using the reference source data obtained through the normal snapshot positioning operation at this time, the first measurement data and the second measurement data stored as the unprocessed measurement data are subject to the snapshot positioning operation, and the positioning data is saved.

Note that, in a case where the number of captured satellites is three or less, it is not possible to perform the snapshot positioning operation even if the reference source data is used. Therefore, the detection device 130 saves or discards the measurement data associated with three or less satellites as unprocessable data, for example.

Although the process of performing, in a case where the number of captured satellites is four in step S509, the snapshot positioning operation using the latest reference source data among the reference source data of each time point at which the number of captured satellites is five or more has been described in the example illustrated in FIG. 5, it is not limited to such a process.

For example, each time step S504 is executed, the reference source data may be stored in association with the time stamp of the measurement data without overwriting. For example, in step S509, the detection device 130 performs the snapshot positioning operation using the reference source data corresponding to the time stamp immediately before or after the time stamp of the current measurement data.

Furthermore, in step S509, the detection device 130 may perform the snapshot positioning operation using the average value or the like of a plurality of reference source data. For example, the detection device 130 performs the snapshot positioning operation using the average or the like of the reference source data corresponding to the time stamp immediately before the time stamp of the current measurement data and the reference source data corresponding to the time stamp immediately after the time stamp of the current measurement data.

Furthermore, the detection device 130 may perform the snapshot positioning operation using the average value or the like of respective reference source data corresponding to two or more time stamps before the time stamp of the current measurement data. Furthermore, the detection device 130 may perform the snapshot positioning operation using the average value or the like of respective reference source data corresponding to two or more time stamps after the time stamp of the current measurement data.

Furthermore, the detection device 130 may estimate (interpolates) the value of the reference source data corresponding to the current measurement data from the respective reference source data corresponding to the plurality of time stamps before and after the current measurement data to perform the snapshot positioning operation using the estimated reference source data.

### Positioning Based on Measurement Data Associated with Four Satellites by Detection Device According to Embodiment

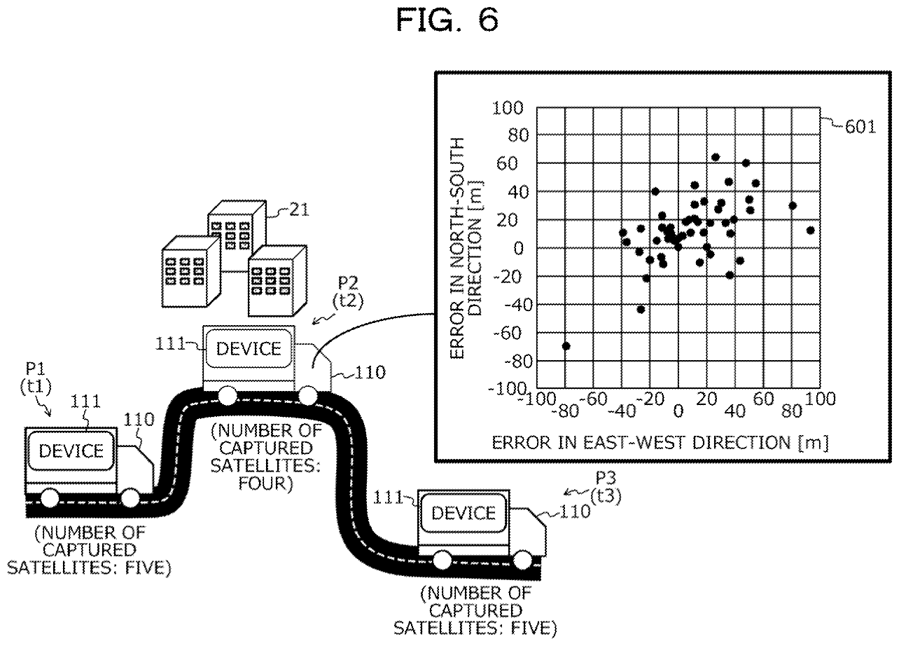

FIG. 6 is a diagram illustrating exemplary positioning based on measurement data associated with four satellites by the detection device according to the embodiment. For example, it is assumed that the truck 110 has traveled in the order of a point P1, a point P2, and a point P3, and the device 111 has captured five satellites at the points P1 and P3 while the device 111 has captured only four satellites at the point P2. Time points t1 to t3 are time points at which the truck 110 has passed the points P1 to P3, respectively.

In this case, the detection device 130 calculates positioning data of the point P1 through the normal snapshot positioning operation based on the measurement data associated with five satellites obtained by the device 111 at the point P1. Furthermore, the detection device 130 calculates positioning data of the point P2 through the snapshot positioning operation based on the solution to the variable dt obtained through the snapshot positioning operation for the point P1 and the measurement data associated with four satellites obtained by the device 111 at the point P2.

Furthermore, the detection device 130 calculates positioning data of the point P3 through the normal snapshot positioning operation based on the measurement data associated with five satellites obtained by the device 111 at the point P3. As a result, it becomes possible to save the positioning data of the points P1 to P3 through which the truck 110 has passed as trace information of the truck 110.

A graph 601 is a distribution chart illustrating a result of repeatedly calculating positioning data at the point P2 under the conditions of FIG. 6. The horizontal axis of the graph 601 represents errors of positional coordinates of positioning data at the point P2 in the east-west direction according to the calculation method described above with respect to the actual positional coordinates of the point P2 in the east-west direction. The vertical axis of the graph 601 represents errors of positional coordinates of positioning data at the point P2 in the north-south direction according to the calculation method described above with respect to the actual positional coordinates of the point P2 in the north-south direction.

As indicated by each plot in the graph 601, by using the calculation method described above, it becomes possible to obtain positioning data with an error within several tens of meters even for the point P2 at which the device 111 has captured only four satellites.

### Identification of Moving Route Using Detection Device According to Embodiment

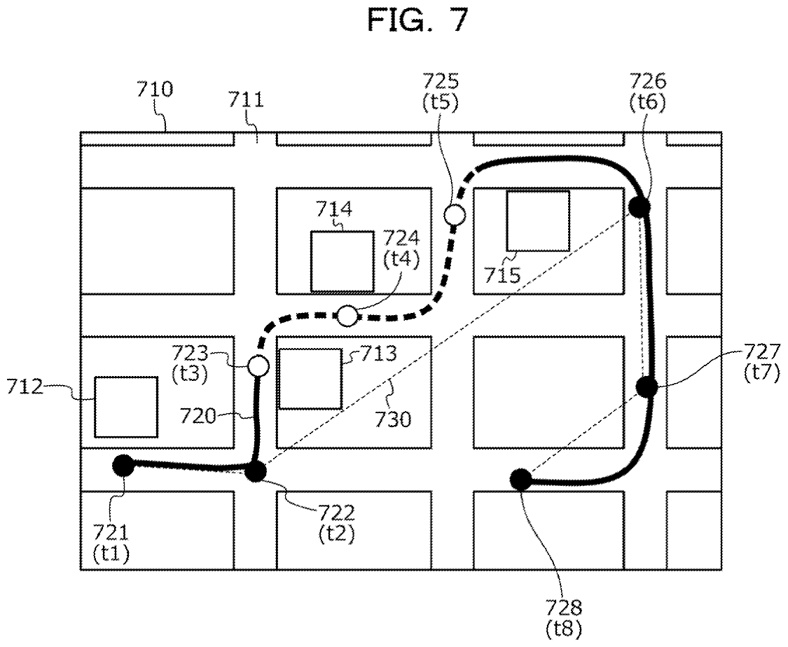

FIG. 7 is a diagram illustrating exemplary identification of a moving route using the detection device according to the embodiment. In FIG. 7, a map 710 indicates the region through which the truck 110 has passed. Roads 711 and shields 712 to 715 on the map 710 are roads and shields (e.g., buildings) in the region where the truck 110 has passed.

A moving route 720 indicates the route actually taken by the truck 110. Times t1 to t8 are respective times at which the device 111 has received data from a satellite while the truck 110 is moving along the moving route 720. Points 721 to 728 are respective points on the moving route 720 at which the truck 110 has been located at the times t1 to t8.

The part indicated by a solid line in the moving route 720 is a part where the device 111 has captured five or more satellites, and the part indicated by a dotted line in the moving route 720 is a part where the device 111 has captured only four satellites. In this case, measurement data associated with five or more satellites is obtained at the points 721, 722, and 726 to 728, and measurement data associated with only four satellites is obtained at the points 723 to 725.

In the example illustrated in FIG. 7, the detection device 130 obtains positioning data of the device 111 through the normal snapshot positioning operation based on the measurement data associated with five or more satellites at the points 721, 722, and 726 to 728. Furthermore, for the points 723 to 725 as well, the detection device 130 performs the snapshot positioning operation based on, for example, the solution to the variable dt obtained through the snapshot positioning operation for the point 722 and the measurement data associated with only four satellites. As a result, it becomes possible to obtain the positioning data of the device 111 even for the points 723 to 725.

An estimated route 730 indicates, as a reference, a moving route of the truck 110 estimated by linear interpolation only from the positioning data of the points 721, 722, and 726 to 728 at which the measurement data associated with five or more satellites has been obtained. The estimated route 730 significantly deviates from the actual moving route 720 of the truck 110 as the points 723 to 725 through which the truck 110 has passed are not taken into consideration.

On the other hand, according to the detection device 130, it becomes possible to obtain not only the positioning data of the points 721, 722, and 726 to 728 but also the positioning data of the points 723 to 725. This makes it possible to accurately estimate the moving route 720 of the truck 110.

### Trace Information Obtained by Detection Device According to Embodiment

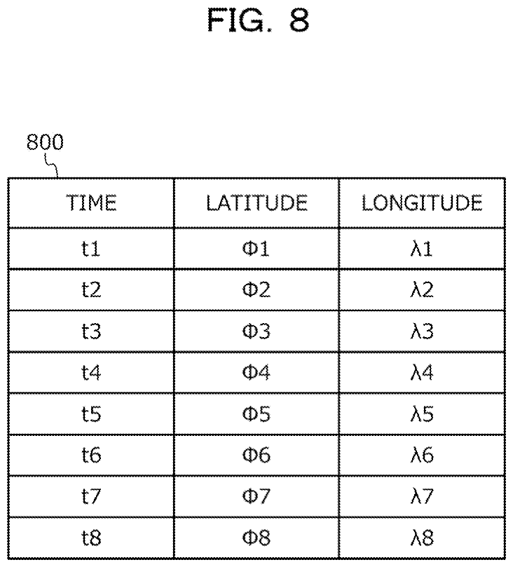

FIG. 8 is a diagram illustrating exemplary trace information to be obtained by the detection device according to the embodiment. In the example illustrated in FIG. 7, the detection device 130 generates trace information 800 illustrated in FIG. 8, for example. The trace information 800 is information indicating estimation results (positioning data) of latitude and longitude in association with each of the times t1 to t8 mentioned above.

Latitudes Φ1 to Φ8 are the latitudes of the positioning data calculated by the detection device 130 for the points 721 to 728 illustrated in FIG. 7, respectively. Longitudes λ1 to λ8 are the longitudes of the positioning data calculated by the detection device 130 for the points 721 to 728 illustrated in FIG. 7, respectively. The trace information 800 makes it possible to accurately estimate the moving route 720.

As an example, by using information indicating the range of the road 711 in the map 710 and the trace information 800, it becomes possible to generate an image in which a line indicating the moving route 720 is superimposed on the map 710. Note that the trace information 800 may be information in which the times t1 to t8 are omitted.

### First Method of Calculating Positioning Data by Detection Device According to Embodiment

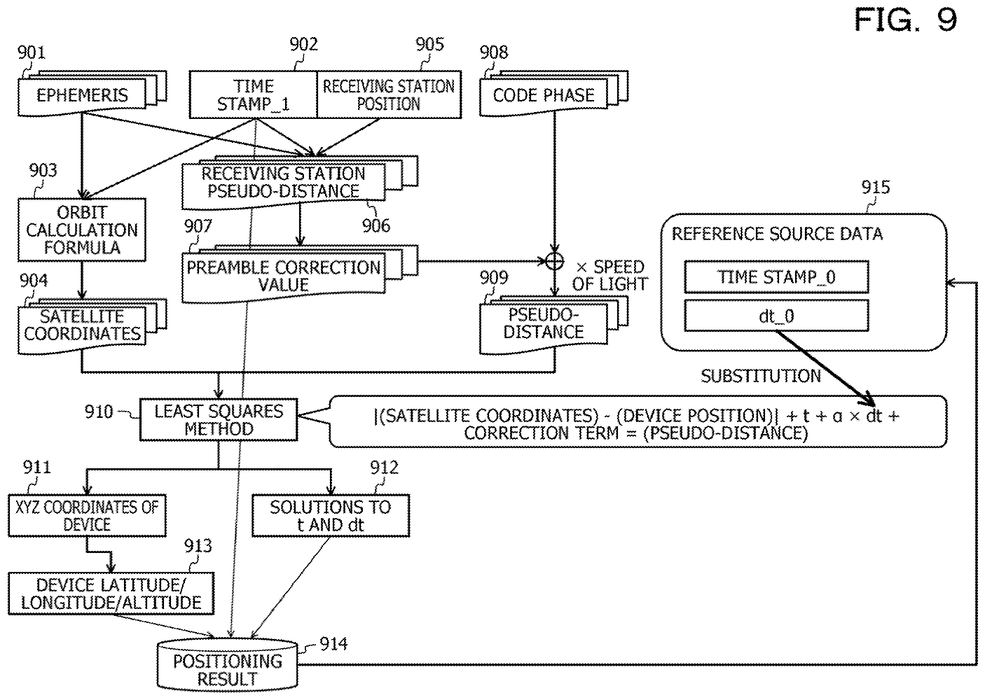

FIG. 9 is a diagram illustrating an exemplary first method of calculating positioning data by the detection device according to the embodiment. An ephemeris 901 is information indicating, for each satellite, the orbit and state of the satellite, correction information of the internal clock (atomic clock) of the satellite, and the like. A time stamp 902 (time stamp_1) is a time stamp attached to the measurement data obtained from the device 111 by the detection device 130 via the receiving station 120.

An orbit calculation formula 903 is a calculation formula capable of calculating positional coordinates of each satellite at a specific time on the basis of the ephemeris 901. The detection device 130 calculates, on the basis of the ephemeris 901 and the orbit calculation formula 903, satellite coordinates 904 indicating the positional coordinates of each satellite indicated by the measurement data at the time indicated by the time stamp 902.

A receiving station position 905 is the positional coordinates of the receiving station 120. The detection device 130 calculates, on the basis of the ephemeris 901 and the receiving station position 905, a receiving station pseudo-distance 906 for each satellite indicated by the measurement data. The receiving station pseudo-distance 906 is a distance between the receiving station 120 and each satellite indicated by the measurement data at the time indicated by the time stamp 902, which includes an error. The detection device 130 calculates, for each of the receiving station pseudo-distance 906 for each satellite, a preamble correction value 907 for each satellite by discarding the code phase component.

A code phase 908 is a code phase of the data received from each satellite by the device 111, which is indicated by the measurement data obtained from the device 111 by the detection device 130 via the receiving station 120. The detection device 130 calculates a pseudo-distance 909 for each satellite by multiplying, by the speed of light c, the observed value obtained by adding the preamble correction value 907 and the code phase 908. The pseudo-distance 909 is a distance between the device 111 and each satellite indicated by the measurement data at the time indicated by the time stamp 902, which includes an error.

The detection device 130 calculates solutions 911 and 912 by performing a least squares method 910 based on the satellite coordinates 904 and the pseudo-distance 909. The solution 911 is solutions to the variables X, Y, and Z that indicate the XYZ coordinates of the device 111. The solution 912 is solutions to the variables t and dt described above related to the time lag of the device 111.

Next, the detection device 130 converts the XYZ coordinates of the device 111 indicated by the solution 911 into device latitude/longitude/altitude 913, which is a coordinate system of latitude, longitude, and altitude. Furthermore, the detection device 130 saves, as a positioning result 914, the device latitude/longitude/altitude 913 and the solutions to the variables t and dt indicated by the solution 912 in association with the time stamp 902. Furthermore, the detection device 130 stores, as reference source data 915 (time stamp_0 and dt_0), the time stamp 902 and the solution to the variable dt saved as the positioning result 914.

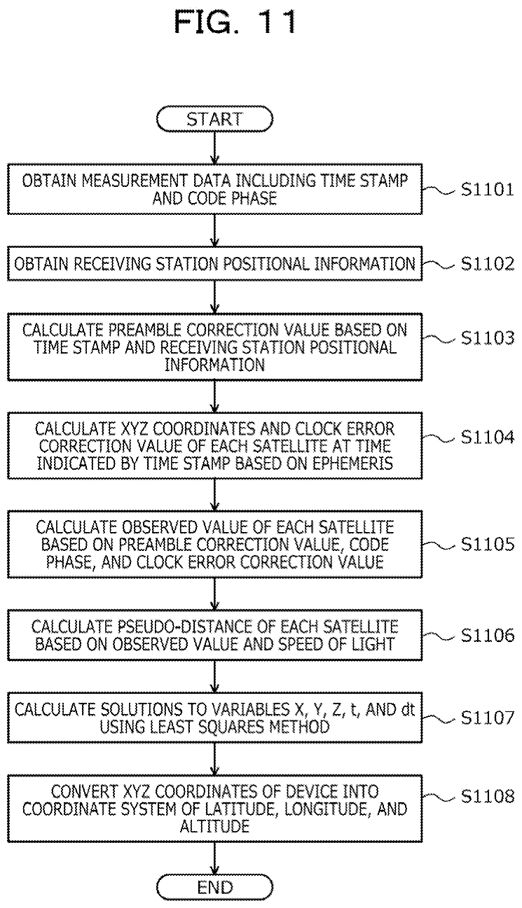

In the least squares method 910 mentioned above, the detection device 130 calculates solutions to the variables X, Y, Z, t, and dt satisfying, for example, |(satellite coordinates)−(device position)|+t+α×dt+correction term=(pseudo-distance). At this time, in a case where the measurement data (time stamp 902 and code phase 908) associated with five or more satellites has been obtained, the solutions to the variables X, Y, Z, t, and dt may be calculated by performing the least squares method of five variables as the least squares method 910. An example of calculating the solutions to the variables X, Y, Z, t, and dt by performing the least squares method of five variables will be described later (e.g., see FIGS. 11 to 13).

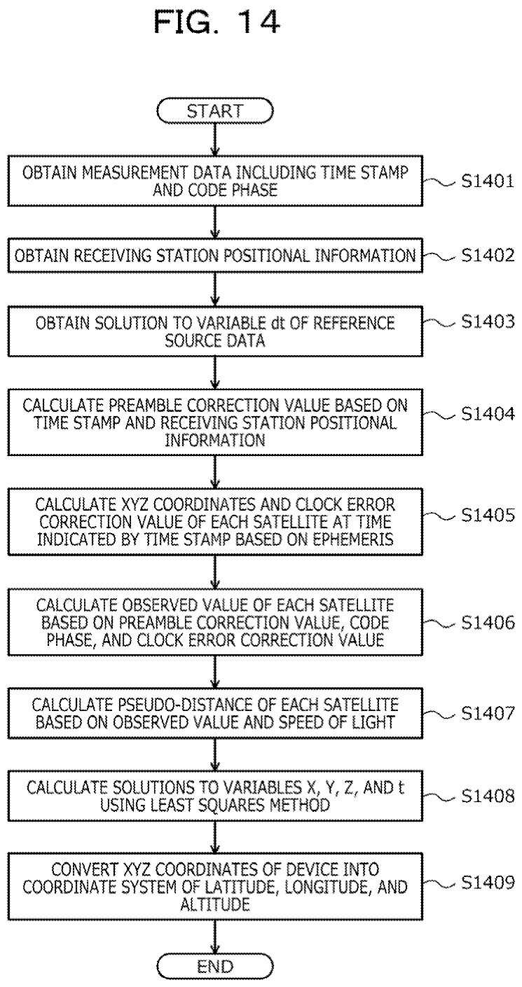

Meanwhile, in a case where only the measurement data associated with only four satellites has been obtained, it is not possible to perform the least squares method of five variables as the least squares method 910. In this case, the detection device 130 may calculate the solutions to the variables X, Y, Z, and t by substituting the solution of dt (dt_0) included in the reference source data 915 into the variable dt of the formula mentioned above and performing the least squares method of four variables as the least squares method 910. An example of calculating the solutions to the variables X, Y, Z, and t by performing the least squares method of four variables will be described later (e.g., see FIGS. 14 to 16).

Although the method of calculating the receiving station pseudo-distance 906 and the preamble correction value 907 in the case where the measurement data associated with five or more satellites is obtained has been described in the example illustrated in FIG. 9, it is not limited to such a calculation method. For example, in the case where the measurement data associated with five or more satellites has been obtained, the detection device 130 may calculate landmarks and grid points for each satellite instead of the receiving station pseudo-distance 906 and the preamble correction value 907. In this case, the detection device 130 filters the obtained device latitude/longitude/altitude 913 by an altitude within a predetermined range that can be assumed as a landmark on the ground, and saves it as the positioning result 914.

### Second Method of Calculating Positioning Data by Detection Device According to Embodiment

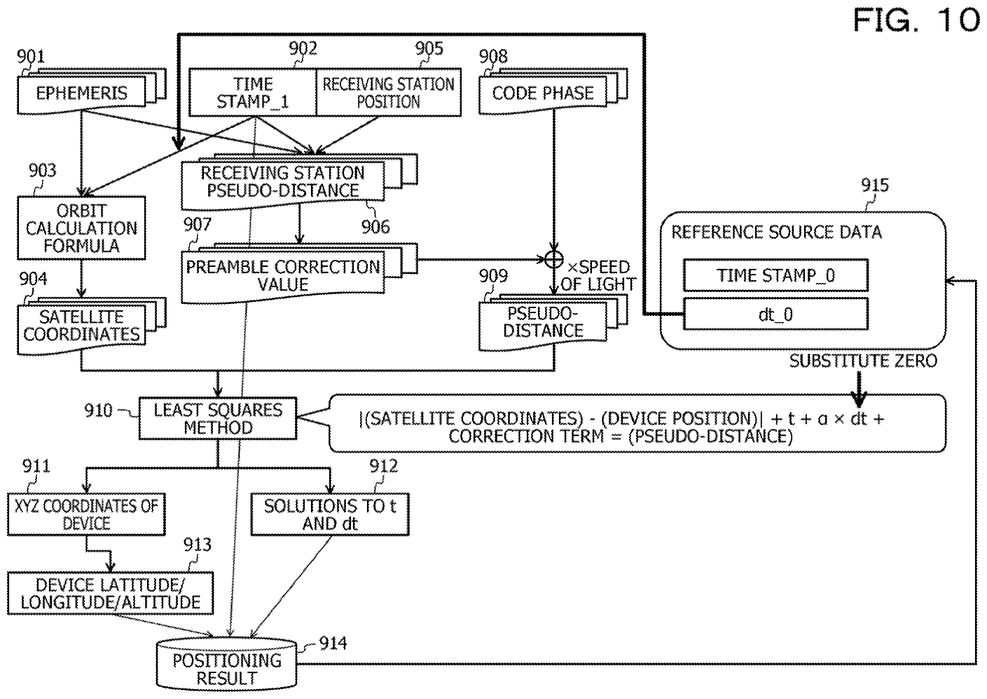

FIG. 10 is a diagram illustrating an exemplary second method of calculating positioning data by the detection device according to the embodiment. In FIG. 10, portions similar to those illustrated in FIG. 9 are denoted by the same reference signs, and descriptions thereof will be omitted. In the case where only the measurement data associated with only four satellites has been obtained, the detection device 130 may calculate the solutions to the variables X, Y, Z, and t by the second calculation method illustrated in FIG. 10, for example.

In the example illustrated in FIG. 10, positional coordinates for each satellite indicated by the measurement data at the time obtained by adding the solution to dt_0 of the reference source data 915 to the time indicated by the time stamp 902 are calculated as the satellite coordinates 904. This makes it possible to correct the target time of the satellite coordinates 904 to the time at which the solution to dt becomes zero.

Then, the detection device 130 substitutes zero for the variable dt in the formula mentioned above in the least squares method 910. This makes it possible to calculate the solutions to the variables X, Y, Z, and t same as in the first calculation method illustrated in FIG. 9.

### Normal Snapshot Positioning Operation by Detection Device According to Embodiment

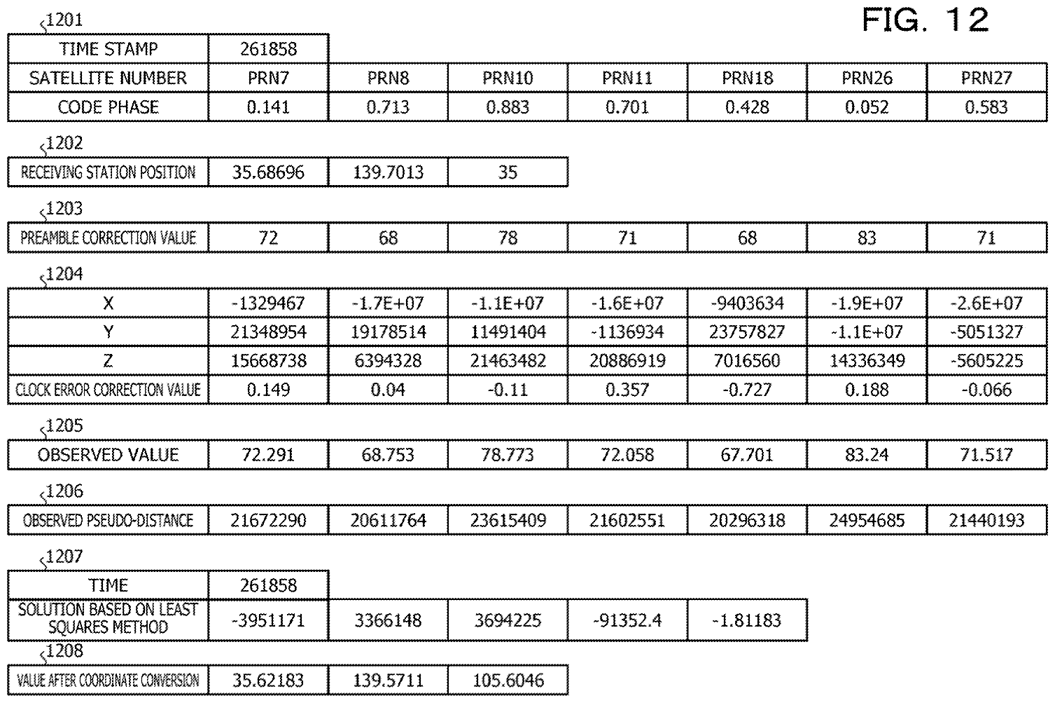

FIG. 11 is a flowchart illustrating an example of the normal snapshot positioning operation by the detection device according to the embodiment. FIG. 12 is a diagram illustrating an example of each information to be calculated in the normal snapshot positioning operation by the detection device according to the embodiment.

In step S503 illustrated in FIG. 5, for example, the detection device 130 executes a process illustrated in FIG. 11, for example, as the normal snapshot positioning operation based on the measurement data associated with five or more satellites.

First, the detection device 130 obtains measurement data including a time stamp and a code phase for each satellite received from the receiving station 120 (step S1101). For example, the detection device 130 obtains measurement data 1201 illustrated in FIG. 12. The measurement data 1201 includes a time stamp, a satellite number, and a code phase.

The time stamp of the measurement data 1201 is information indicating the time at which the measurement data 1201 has been obtained. For example, the time stamp is a time stamp generated on the basis of the internal time of the receiving station 120 when the receiving station 120 has received the measurement data 1201 (excluding time stamp) from the device 111 and added to the measurement data 1201. Furthermore, the time stamp may be a time stamp generated on the basis of the internal time of the device 111 when the device 111 has received the data from each satellite and generated the measurement data 1201 (excluding time stamp) and added to the measurement data 1201. In the example illustrated in FIG. 12, the time stamp is “261858”.

The satellite number of the measurement data 1201 is an identifier of each satellite captured (having been subject to data reception) by the device 111. In the example illustrated in FIG. 12, the satellite numbers are the satellite numbers of seven satellites of “PRN7”, “PRN8”, “PRN10”, and so on.

The code phase of the measurement data 1201 is a phase of the part of the code of the data transmitted by the satellite received by the device 111. In the example illustrated in FIG. 12, the code phases of the seven satellites indicated by the satellite numbers “PRN7”, “PRN8”, “PRN10”, and so on are “0.141”, “0.713”, “0.883”, and so on, respectively.

The satellite numbers and the code phases of the measurement data 1201 may be obtained by, for example, decoding the data received from the satellite by the device 111. As described above, the measurement data 1201 illustrated in FIG. 12 indicates that the device 111 has received data from seven satellites at the time indicated by the time stamp “261858”, and code phases thereof are “0.141”, “0.713”, “0.883”, and so on, respectively.

Next, the detection device 130 obtains receiving station positional information indicating the position of the receiving station 120 (step S1102). For example, the receiving station positional information is stored in the memory 402 of the detection device 130 in advance, and the detection device 130 reads the positional information from the memory 402. Alternatively, the detection device 130 may receive the receiving station positional information from the receiving station 120 or another communication device. For example, the detection device 130 obtains receiving station positional information 1202 illustrated in FIG. 12. The receiving station positional information 1202 represents the position of the receiving station 120 (receiving station position) by latitude, longitude, and altitude.

Next, the detection device 130 calculates a preamble correction value for each satellite on the basis of the time stamp included in the measurement data 1201 obtained in step S1101 and the receiving station positional information 1202 obtained in step S1102 (step S1103). For example, the detection device 130 calculates preamble correction value information 1203 illustrated in FIG. 12. In the example illustrated in FIG. 12, the preamble correction value information 1203 is calculated for each of the seven satellites mentioned above.

Furthermore, on the basis of the ephemeris, the detection device 130 performs orbit calculation for each satellite and calculates XYZ coordinates (X, Y, Z) and a dock error correction value of each satellite at the time indicated by the time stamp of the measurement data 1201 (step S1104). The ephemeris is information including the orbit and state of each satellite including the seven satellites mentioned above, correction information of the internal clock (atomic clock) of each satellite, and the like. For example, the detection device 130 receives the ephemeris from a server or the like via a network. Alternatively, the detection device 130 may receive the ephemeris transmitted from each satellite via the device 111 or the receiving station 120.

For example, the detection device 130 generates satellite coordinates/clock error correction value information 1204 illustrated in FIG. 12. The satellite coordinates/clock error correction value information 1204 indicates, for each of the seven satellites mentioned above, XYZ coordinates (X, Y, Z) and a clock error correction value of each satellite at the time indicated by the time stamp of the measurement data 1201.

Next, the detection device 130 calculates an observed value of each satellite on the basis of the preamble correction value of the preamble correction value information 1203, the code phase of the measurement data 1201, and the clock error correction value of the satellite coordinates/dock error correction value information 1204 (step S1105). The observed value fora certain satellite is calculated by, for example, a preamble correction value+a code phase+a clock error correction value. For example, the detection device 130 generates observed value information 1205 illustrated in FIG. 12. In the observed value information 1205, for example, the observed value for the satellite of “PRN7” is 0.141+72+0.149≈72.291.

Next, the detection device 130 calculates a pseudo-distance (observed pseudo-distance) of each satellite on the basis of the observed value and the speed of light of the observed value information 1205 (step S1106). The pseudo-distance of each satellite is each distance between each satellite and the device 111, and includes an error. A pseudo-distance for a certain satellite is calculated by, for example, an observed value×speed of light. For example, the detection device 130 generates pseudo-distance information 1206 illustrated in FIG. 12. In the pseudo-distance information 1206, for example, the pseudo-distance for the satellite of “PRN7” is 72.291*speed of light □ 21672290.

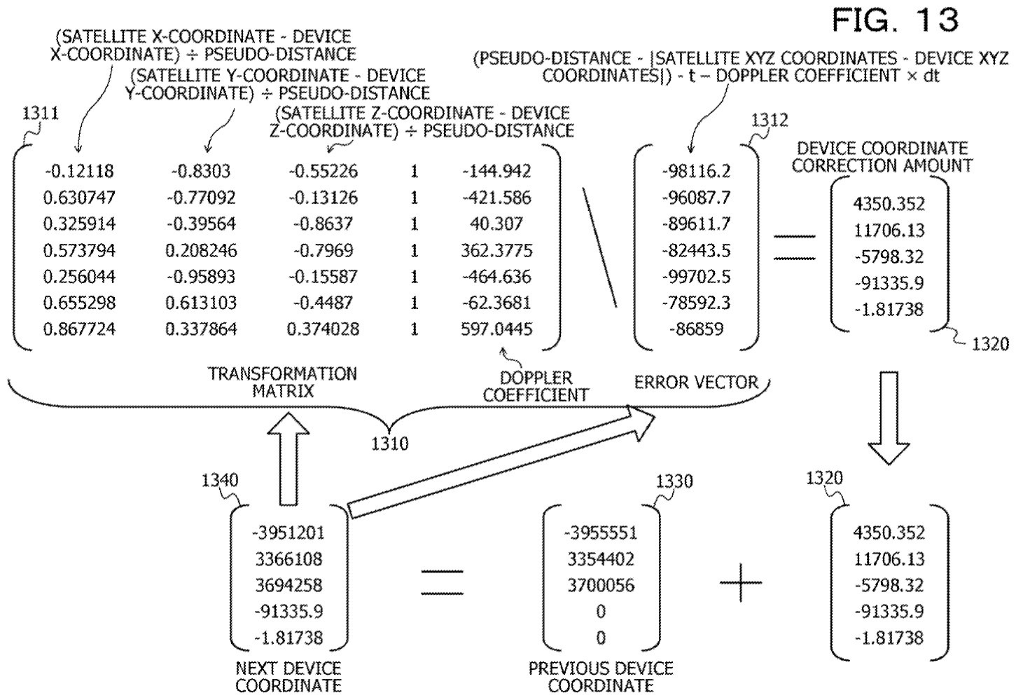

Next, the detection device 130 calculates solutions to the variables X, Y, Z, t, and dt using the least squares method based on the XYZ coordinates of each satellite calculated in step S1104 and the pseudo-distance of each satellite calculated in step S1106 (step S1107). For example, the detection device 130 generates solution information 1207 illustrated in FIG. 12. The calculation of the solution using the least squares method will be described later (e.g., see FIG. 13).

Next, the detection device 130 converts the XYZ coordinates of the device 111 indicated by the solution information 1207 into a coordinate system of latitude, longitude, and altitude (step S1108), and a series of processing is terminated. For example, the detection device 130 generates positioning data 1208 illustrated in FIG. 12. The positioning data 1208 includes the latitude, longitude, and altitude of the device 111 as values after the coordinates conversion of the XYZ coordinates of the device 111 indicated by the solution information 1207.

Formulation in the least squares method of step S1107 will be described. An error (i) for a certain satellite (i) may be expressed by, for example, the following formula (1).

Error(i)=(pseudo-distance(i)−|satellite position(i)−variable(X,Y,Z)|)−variable(t)−correction term (1)

Here, as an initial value, an appropriate value (e.g., zero) is given to X, Y, Z, and t, which are variables. The determinant that formulates the formula (1) mentioned above for each satellite is to be the following formula (2).

(Transformation matrix)*(variable vector(X,Y,Z,t))=(error vector)

(variable(X,Y,Z,t))=(transformation matrix) [symbol] (error vector) (2)

Here, a minute change in the positional coordinates of the device 111, such as from X to X+dX, will be considered. Partial differentiation of each term in the formula (2) mentioned above with coordinates X, Y, and Z is to be the following formula (3).

Minute change(X,Y,Z,t)=d transformation matrix [symbol] (error vector) (3)

The detection device 130 performs the operation of repeating the formulation of the formula (3) mentioned above and correction of the variable vector in the direction of reducing the error vector until the error becomes sufficiently small. This makes it possible to obtain the position of the device 111 (solutions to the variables X, Y, and Z) at the time when the observed pseudo-distance (pseudo-distance information 1206) and the distance in the orbit calculation match.

### Calculation of Solution in Normal Snapshot Positioning Operation by Detection Device According to Embodiment

FIG. 13 is a diagram illustrating exemplary calculation of a solution in the normal snapshot positioning operation by the detection device according to the embodiment. An example of calculating a solution in the normal snapshot positioning operation in step S1107 illustrated in FIG. 11 will be described.

For example, the detection device 130 generates (formulates) a formula 1310 illustrated in FIG. 13 on the basis of the XYZ coordinates of each satellite calculated in step S1104 and the pseudo-distance of each satellite calculated in step S1106. The formula 1310 is (transformation matrix 1311) [symbol] (error vector 1312)=(device coordinate correction amount 1320).

The transformation matrix 1311 is a matrix having respective rows corresponding to the respective satellites (seven satellites in this case) from which the device 111 has received data and five columns. The first column (leftmost column) of the transformation matrix 1311 represents values calculated by (satellite X-coordinate−device X-coordinate)÷pseudo-distance for the respective seven satellites. Here, the satellite X-coordinate is the X-coordinate of the satellite calculated in the orbit calculation in step S1104. The device X-coordinate is the X-coordinate of the device 111 to which an appropriate value (e.g., zero) is assigned as an initial value.

The second column of the transformation matrix 1311 represents values calculated by (satellite Y-coordinate−device Y-coordinate)÷pseudo-distance for the respective seven satellites. Here, the satellite Y-coordinate is the Y-coordinate of the satellite calculated in the orbit calculation in step S1104. The device Y-coordinate is the Y-coordinate of the device 111 to which an appropriate value (e.g., zero) is assigned as an initial value.

The third column of the transformation matrix 1311 represents values calculated by (satellite Z-coordinate−device Z-coordinate)÷pseudo-distance for the respective seven satellites. Here, the satellite Z-coordinate is the Z-coordinate of the satellite calculated in the orbit calculation in step S1104. The device Z-coordinate is the Z-coordinate of the device 111 to which an appropriate value (e.g., zero) is assigned as an initial value.

Each row in the fourth column of the transformation matrix 1311 has a value of one. The fifth column of the transformation matrix 1311 represents Doppler coefficients for the respective seven satellites. The Doppler coefficient is calculated by the orbit calculation for each satellite based on the ephemeris mentioned above and the time stamp of the measurement data 1201, for example.

The error vector 1312 represents each value calculated by (pseudo-distance−|satellite XYZ coordinates−device XYZ coordinates|)−t−Doppler coefficient×dt for each of the seven satellites. Here, the satellite XYZ coordinates are the XYZ coordinates of the satellite calculated in the orbit calculation in step S1104. The device XYZ coordinates are the XYZ coordinates of the device 111 indicated by the current values of the variables X, Y, and Z. The deviation (offset) of the internal time of the device 111 with respect to the internal time of the satellite is represented by the variable of t.

The Doppler coefficient×dt is a variable representing a time lag caused by the Doppler effects caused by the device 111 receiving radio waves from the satellite for only a short time in the snapshot positioning, for example. For example, dt is a variable related to the correction amount of t. As an initial value, an appropriate value (e.g., zero) is assigned to the variables t and dt.

The device coordinate correction amount 1320 represents the calculation results of the left side of the formula 1310, which indicates the correction amount of each value of the variables X, Y, Z, t, and dt in the next operation. A previous device coordinate 1330 represents each value of the variables X, Y, Z, t, and dt used in the formula 1310 formulated immediately before. Therefore, in a case where the initial value of the variables X, Y, Z, t, and dt is set to zero, an initial value of each value of the device coordinate correction amount 1320 is also zero.

The detection device 130 calculates a next device coordinate 1340 by adding the device coordinate correction amount 1320 calculated by the formula 1310 formulated immediately before to the previous device coordinate 1330. The next device coordinate 1340 represents each value of the variables X, Y, Z, t, and dt in the next operation. For example, the detection device 130 regenerates the formula 1310 using each value of the next device coordinate 1340.

As described with reference to FIG. 13, the detection device 130 performs the operation of repeating the process of generating the formula 1310 in which the variables X, Y, Z, t, and dt are updated using the device coordinate correction amount 1320 obtained by the formula 1310 until the error indicated by the error vector 1312 becomes sufficiently small. For example, the detection device 130 repeats the operation a predetermined number of times so that the error indicated by the error vector 1312 becomes sufficiently small. Alternatively, the detection device 130 determines the magnitude of the value of the error vector 1312 each time the formula 1310 is generated, and repeats the operation until the magnitude of the value of the error vector 1312 falls within a predetermined range.

Then, the detection device 130 obtains, as each solution to the variables X, Y, Z, t, and dt, each value of the variables X, Y, Z, t, and dt indicated by the next device coordinate 1340 ultimately obtained in the repeated operation.

### Snapshot Positioning Operation Using Reference Source Data by Detection Device According to Embodiment

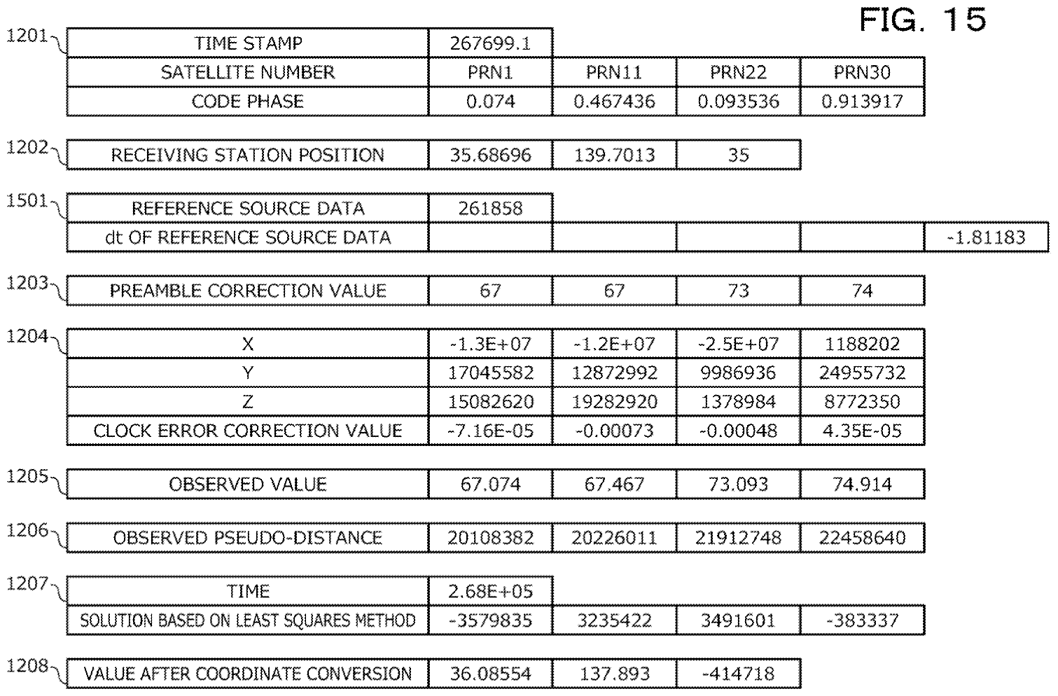

FIG. 14 is a flowchart illustrating an example of the snapshot positioning operation using reference source data by the detection device according to the embodiment. FIG. 15 is a diagram illustrating an example of each information to be calculated in the snapshot positioning operation using the reference source data by the detection device according to the embodiment. In FIG. 15, portions similar to those illustrated in FIG. 12 are denoted by the same reference signs, and descriptions thereof will be omitted.

In step S509 illustrated in FIG. 5, for example, the detection device 130 executes a process illustrated in FIG. 14, for example, as the snapshot positioning operation based on the reference source data and the measurement data associated with four satellites. Here, it is assumed that the detection device 130 has calculated the solutions to the variables X, Y, Z, t, and dt through the normal snapshot positioning operation on the basis of the positioning data at another time point, and has stored the calculated solution to the variable dt (−1.81183) as reference source data 1501. Note that, in the example illustrated in FIG. 15, the reference source data 1501 also includes a time stamp (261858 mentioned above).

Steps S1401 and S1402 illustrated in FIG. 14 are similar to steps S1101 and S1102 illustrated in FIG. 11. The detection device 130 obtains the measurement data 1201 in step S1401. Furthermore, the detection device 130 obtains the receiving station positional information 1202 in step S1402. Subsequent to step S1402, the detection device 130 obtains a solution to the variable dt of the reference source data 1501 (step S1403).

Steps S1404 to S1409 illustrated in FIG. 15 are similar to steps S1103 to S1108 illustrated in FIG. 11. However, in the case of using the first calculation method illustrated in FIG. 9, the detection device 130 calculates the XYZ coordinates and the dock error correction value of each satellite at the time indicated by the time stamp of the measurement data 1201 in step S1405. Furthermore, in the case of using the second calculation method illustrated in FIG. 10, the detection device 130 calculates the XYZ coordinates and the clock error correction value of each satellite at the time obtained by adding the solution to the variable dt obtained in step S1403 to the time indicated by the time stamp of the measurement data 1201.

Furthermore, in the case of using the first calculation method illustrated in FIG. 9, the detection device 130 calculates the solutions to the variables X, Y, Z, and t using the least squares method of four variables in which the value of the variable dt is fixed to the solution to the variable dt obtained in step S1403 in step S1408. Furthermore, in the case of using the second calculation method illustrated in FIG. 10, the detection device 130 calculates the solutions to the variables X, Y, Z, and t using the least squares method of four variables in which the value of the variable dt is fixed to zero.

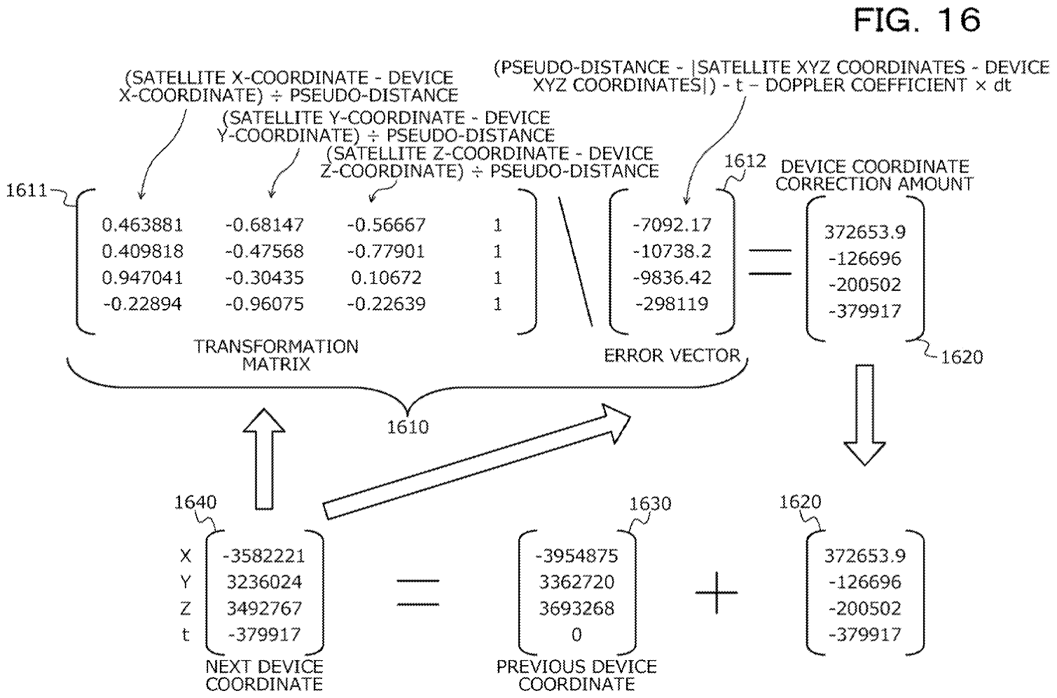

This makes it possible to calculate the solutions to the variables X, Y, Z, and t on the basis of the measurement data associated with only four satellites. An example of calculating the solution in step S1408 will be described with reference to FIG. 16.

### Calculation of Solution in Snapshot Positioning Operation Using Reference Source Data by Detection Device According to Embodiment

FIG. 16 is a diagram illustrating exemplary calculation of a solution in the snapshot positioning operation using the reference source data by the detection device according to the embodiment. An example of calculating a solution in the snapshot positioning operation using the reference source data in step S1408 illustrated in FIG. 14 will be described.

For example, the detection device 130 generates (formulates) a formula 1610 illustrated in FIG. 16 on the basis of the solution to the variable dt obtained in step S1403, the XYZ coordinates of each satellite calculated in step S1405, and the pseudo-distance of each satellite calculated in step S1407. The formula 1610 is (transformation matrix 1611) [symbol] (error vector 1612)=(device coordinate correction amount 1620).

The transformation matrix 1611 is a matrix having respective rows corresponding to the respective satellites (four satellites in this case) captured by the device 111 and four columns. The first column (leftmost column) of the transformation matrix 1611 represents values calculated by (satellite X-coordinate−device X-coordinate)+pseudo-distance for the respective four satellites.

The second column of the transformation matrix 1611 represents values calculated by (satellite Y-coordinate−device Y-coordinate)+pseudo-distance for the respective four satellites. The third column of the transformation matrix 1611 represents values calculated by (satellite Z-coordinate−device Z-coordinate)+pseudo-distance for the respective four satellites. Each row in the fourth column of the transformation matrix 1611 has a value of one.

The error vector 1612 represents each value calculated by (pseudo-distance−|satellite XYZ coordinates−device XYZ coordinates|)−t−Doppler coefficient×dt for each of the four satellites. Here, in the case of using the first calculation method illustrated in FIG. 9, the solution to the variable dt obtained in step S1403 is substituted into dt as a fixed value. Furthermore, in the case of using the second calculation method illustrated in FIG. 10, zero is substituted into dt as a fixed value.

The device coordinate correction amount 1620 represents the calculation results of the left side of the formula 1610, which indicates the correction amount of each value of the variables X, Y, Z, and t in the next operation. A previous device coordinate 1630 represents each value of the variables X, Y, Z, and t used in the formula 1610 formulated immediately before.

The detection device 130 calculates a next device coordinate 1640 by adding the device coordinate correction amount 1620 calculated by the formula 1610 formulated immediately before to the previous device coordinate 1630. The next device coordinate 1640 represents each value of the variables X, Y, Z, and t in the next operation. For example, the detection device 130 regenerates the formula 1610 using each value of the next device coordinate 1640.

As described with reference to FIG. 16, the detection device 130 performs the operation of repeating the process of generating the formula 1610 in which the variables X, Y, Z, and t are updated using the device coordinate correction amount 1620 obtained by the formula 1610 until the error indicated by the error vector 1612 becomes sufficiently small. Then, the detection device 130 obtains, as each solution to the variables X, Y, Z, and t, each value of the variables X, Y, Z, and t indicated by the next device coordinate 1640 ultimately obtained in the repeated operation.

As described above, according to the embodiment, the positioning solution may be obtained from the respective data received from the four satellites by the device at the second time point by using the solution to the fifth variable among the positioning solutions calculated from the respective data received from the five or more satellites by the device at the first time point. This makes it possible to obtain, in the snapshot positioning, the positioning solution even in a case where the number of captured satellites by the device is less than a predetermined number (five).

Furthermore, even in a case where the device is not provided with an acceleration sensor or the like, for example, the positioning solution may be obtained even at the time point when the device has received data from only four or less satellites. Therefore, it becomes possible to suppress the manufacturing cost and the power consumption of the device.

Although the configuration in which the measurement data from the device 111 is transmitted to the detection device 130 via the receiving station 120 has been described in the embodiment above, it is not limited to such a configuration. For example, the detection device 130 may be provided with the function of the receiving station 120 so that the detection device 130 directly receives the measurement data from the device 111.

Furthermore, although the positioning method (e.g., CO-GPS) in which the detection of the position of the device 111 is performed in the external detection device 130 instead of the device 111 has been described in the embodiment above, it is not limited to such a configuration. For example, the device 111 may be provided with the function of the detection device 130 so that the device 111 performs the detection of the position of the device 111.

Furthermore, the configuration of performing positioning of the device 111 to obtain the trace information of the truck 110 has been described in the embodiment above, it is not limited to such a configuration. For example, the target for installing the device 111 or having the device 111 is not limited to the truck 110. For example, with the device 111 carried by a child or an elderly person, it becomes possible to provide a watching service by identifying the position or moving route of the child or the elderly person.

Furthermore, with the device 111 attached to a wild animal or the like, it becomes possible to conduct a survey by identifying the position or the moving route of the wild animal or the like. Furthermore, with the device 111 provided on various front terminals of Internet of things (IoT), it becomes possible to provide various services of the IoT by identifying the position or the moving route of the front terminal.

As described above, according to the detection method and the detection program, it becomes possible to obtain positioning solution even in a case where the number of captured satellites is less than a predetermined number.

For example, for target data for which the number of captured satellites is only four and a positioning solution cannot be obtained, it becomes possible to obtain a positioning solution by fixing the fifth variable in the snapshot positioning operation on the basis of data that can be positioned at a different time point and its measurement time (dt).

Note that the detection method described in the present embodiment may be implemented by executing a program prepared in advance on a computer such as a personal computer or a workstation. This program is recorded on a computer-readable recording medium such as a hard disk, a flexible disk, a compact disc-read only memory (CD-ROM), or a digital versatile disc (DVD), and is read from the recording medium to be executed by the computer. Furthermore, the program may be a transmission medium capable of being distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A detection method comprising:
calculating, by a computer, on a basis of a result of a device having received data from five or more satellites at a first time point, a solution to an equation including first to third variables indicating a three-dimensional position of the device, a fourth variable indicating deviation of internal time of the device, and a fifth variable indicating a time lag caused by a Doppler effect between the device and the satellites;
calculating a solution to an equation including the first to fourth variables on a basis of a result of the device having received data from four satellites at a second time point different from the first time point and a solution to the fifth variable calculated for the first time point; and
outputting positional information of the device based on calculated each solution to the first to third variables for each of the first time point and the second time point.

2. The detection method according to claim 1, wherein
at a time of calculating the solution for the second time point, a solution to an equation in which a value of the fifth variable in the equation including the first to fifth variables is fixed to the solution to the fifth variable for the first time point is calculated.

3. The detection method according to claim 1, wherein
at a time of calculating the solution for the first time point, the solution to the equation including the first to fifth variables is calculated using snapshot positioning operation.

4. The detection method according to claim 1, wherein
the first time point is a time point immediately before the second time point among respective time points at which the device has received data from the satellites.

5. The detection method according to claim 1, wherein
the positional information of the device is output in association with time at which the device has received data used to calculate the positional information of the device from the satellites.

6. A non-transitory computer-readable recording medium storing a detection program causing a computer to execute processing of:
calculating, on a basis of a result of a device having received data from five or more satellites at a first time point, a solution to an equation including first to third variables indicating a three-dimensional position of the device, a fourth variable indicating deviation of internal time of the device, and a fifth variable indicating a time lag caused by a Doppler effect between the device and the satellites;
calculating a solution to an equation including the first to fourth variables on a basis of a result of the device having received data from four satellites at a second time point different from the first time point and a solution to the fifth variable calculated for the first time point; and
outputting positional information of the device based on calculated each solution to the first to third variables for each of the first time point and the second time point.
